(19) United States
(12) Patent Application Publication
(10) Pub. No.: US 2008/0030099 A1
(43) Pub. Date: Feb. 7, 2008

(54) Carbon Brush For An Electrical Machine

(76) Inventor: Robert Heitz, Rastatt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/587,437

(22) PCT Filed: Mar. 4, 2005
(86) PCT No.: PCT/EP05/50984

§ 371 Date: Oct. 25, 2006

(30) Foreign Application Priority Data
May 12, 2004 (DE) 10 2004 023 398.5

(51) Int. Cl. H01R 39/39

(52) U.S. Cl. 310/244

(57) ABSTRACT

A carbon brush for an electrical machine for pivotable support on a brush holder of the electrical machine includes a bearing portion embodied on the carbon brush itself for pivotably supporting the carbon brush. This can be done in the form of a bore of a cylindrical portion. This has the advantage that the position of the carbon brush relative to the commutator does not vary especially markedly even in the event of major temperature fluctuations. Moreover, the carbon brush can be well positioned in a brush holder which assures a precise association with the commutator.

### PRIOR ART

The invention is based on a carbon brush for an electrical machine as generically defined by the preamble to claim 1. A carbon brush of this kind is pivotably supported on a brush holder of the electrical machine. However, the carbon brush is supported in a plastic part, which in turn is supported pivotably on the brush holder. If major temperature fluctuations occur, the position of the contact region of the carbon brush relative to the commutator can change sharply because of the temperature coefficient of the plastic. If metal parts are used, then both the weight and costs rise.

Another kind of pivotable carbon brushes are hammer brushes, in which the carbon brush is secured to a leaf spring. The power supply is effected via a pigtail or directly via the leaf spring that is welded to the carbon brush. Production variations can cause an offset in height between the carbon brush and the ideal contact height on the commutator. As a result, noise development cannot be precluded.

### ADVANTAGES OF THE INVENTION

The carbon brush for an electrical machine having the characteristics of claim 1 has the advantage that the position of the carbon brush relative to the commutator does not vary especially markedly, even in the event of major temperature fluctuations. Moreover, the carbon brush can be well positioned in a brush holder, which assures a precise association with the commutator. To this end, a carbon brush for an electrical machine for pivotable support on a brush holder of the electrical machine is provided; a bearing portion for pivotably supporting the carbon is embodied on the carbon itself.

A simple repositioning of the carbon brush exists if the bearing portion of the carbon brush is adjoined by a swivel arm, from which a contact portion, for contact with a commutator of a commutator motor or with a wiper ring of a generator, protrudes transversely.

If the length of the swivel arm is essentially equivalent to the radius of the commutator motor or wiper ring, then the carbon brush can be mounted on a brush holder which extends parallel to the shaft of an electrical machine.

Simple embodiments of the bearing portion are possible if it is embodied as a cylindrical portion for being received in a bearing shell, or if it has a bore for receiving a bearing pin.

An electrical pigtail lead is preferably secured to the swivel arm or to the contact portion, because by that means favorable electrical connections can be made.

If a spring for exerting a pressure force on the contact portion engages the swivel arm or the contact portion, good lever ratios are obtained, and as a result the spring need not be as strong. Preferably, the spring is secured to the swivel arm and merges via a curved portion with a spring arm that extends essentially along the swivel arm in the direction of the bearing portion.

Brush holders with bearings for pivotably supporting carbon brushes, and with carbon brushes of the kind in which bearing portions are embodied on the carbon brushes themselves and are received in the bearings, are inexpensive. The brush holder has bearing shells or pins, on which the carbon brushes are supported, which makes an economical kind of support possible.

The springs secured to the carbon brushes are preferably braced on the brush holder, which makes for a compact construction. Simple integration of the springs with the brush holder is obtained if spring arms are embodied on the brush holder and engage recesses in the carbon brushes. A simple construction is also obtained if torsion springs are provided, which are disposed on the bearings or on the carbon brushes themselves and which have legs that exert the contact pressure on the carbon brushes.

An electrical machine with such carbon brushes or with a brush holder of this kind is inexpensive in its construction and has good noise behavior.

Further advantages and advantageous refinements will become apparent from the dependent claims and the description.

### DRAWINGS

One exemplary embodiment is shown in the drawing and described in further detail in the ensuing description. Shown are:

FIG. 1, an electric motor in longitudinal section;

FIG. 2, a first commutating device of the electric motor;

FIG. 3, a second commutating device; and

FIG. 4, a third commutating device.

### DESCRIPTION OF THE EXEMPLARY EMBODIMENT

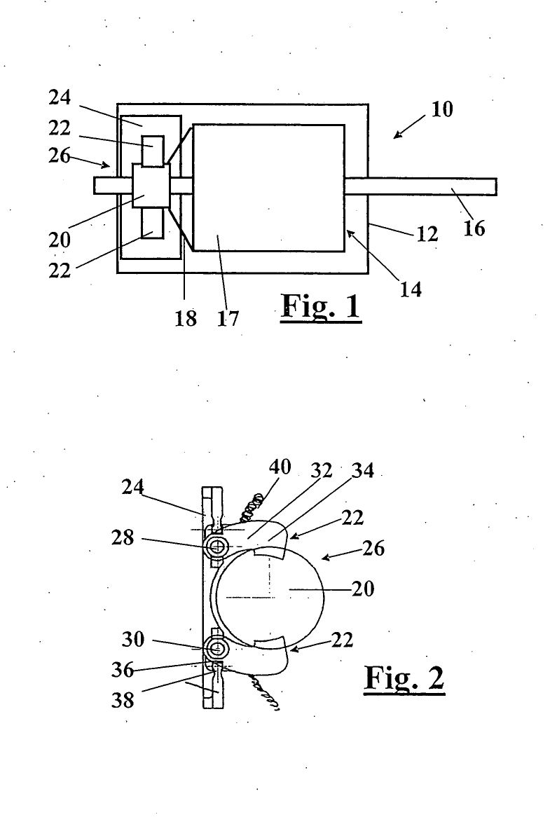

In FIG. 1, an electric motor 10, which may instead be a generator, is shown in simplified form in a longitudinal section. The electric motor 10 can be used in a motor vehicle, for instance in a power window system, wiper drive mechanism, blower, etc. The electric motor 10 includes a housing 12 and an armature 14 disposed in the housing. The armature 14 has a shaft 16 and an armature packet 17 with an armature winding, not provided with a reference numeral. The armature winding is connected via wires 18 to a commutator 20. The commutator 20 is acted upon on its circumference by two carbon brushes 22 on two radially opposed sides. The carbon brushes 22 are disposed on a brush holder 24. The commutator 20, carbon brushes 22, and brush holder 24 form a commutating device 26.

In FIG. 2, the commutating device 26 is shown in a side view from the left, in terms of the longitudinal section in FIG. 1. The brush holder 24, which is preferably of plastic, extends substantially parallel to the shaft 16, which is not shown in detail in FIG. 2; however, the brush holder may also extend perpendicular to the shaft 16. The brush holder 22 has two bearings in the form of pins 28, which extend parallel to the commutator axis, for pivotably supporting the carbon brushes 22. The spacing of the pins 28 from one another is preferably at least as great as the diameter of the commutator 20. The spacing of the pins 28 from the commutator axis is at least 1.5 times the commutator radius. As a result, premature wear of the carbon brush 20 does not occur.

Bearing portions in the form of bores 30 are embodied on the carbon brushes 22 themselves and are slipped onto the pins 28. In other words, the bearing portions are embodied integrally with or on the carbon brushes 22.

The bearing portions or bores 30 are each adjoined by a swivel arm 32. The length of the swivel arm 32 is preferably approximately equivalent to the radius of the commutator 20. The length of the swivel arm 32 is dimensioned such that contact regions 34 for resting on the commutator 20 of the two carbon brushes 22 are located diametrically opposite the commutator 20. The respective contact region 34 protrudes transversely and diagonally from the swivel arm 32 and has a shorter length than the swivel arm 32. The cross-sectional area of the carbon brush 22 is rectangular, and preferably square.

In the region of the support, two slits 36 or recesses are embodied on the carbon brushes 22; they are perpendicular to the bores 30. Spring arms 38 are disposed in the slits 36. The spring arms 38 act on the carbon brushes 22 in such a way that they are pressed against the commutator 20. For the sake of illustration, the carbon brushes 22 are shown in a position that they assume when the commutator 20 is not present. The spring arms 38 are preferably formed integrally onto the brush holder 24 and are of plastic and are located in the same plane. It is advantageous if they are oriented toward one another. This makes for a more space-saving arrangement than if they are pointed away from one another.

Finally, one pigtail 40 is secured to each of the carbon brushes 22 for electrically contacting them. The pigtail 40 is preferably welded, in particular electrically welded, onto the swivel arm 32.

For assembling the commutating device 26, the carbon brushes 22 are slipped onto the pins 28. Simultaneously, the spring arms 38 are introduced into the slits 36. As a result, the angular position of the carbon brushes 22 is thereafter secured, and an intermediate support is optionally possible. For assembly, the commutating device 26, with the carbon brushes 22 in the lead, is pressed against the commutator 20. This forces the carbon brushes 22 apart until the commutating device 26 reaches its final position.

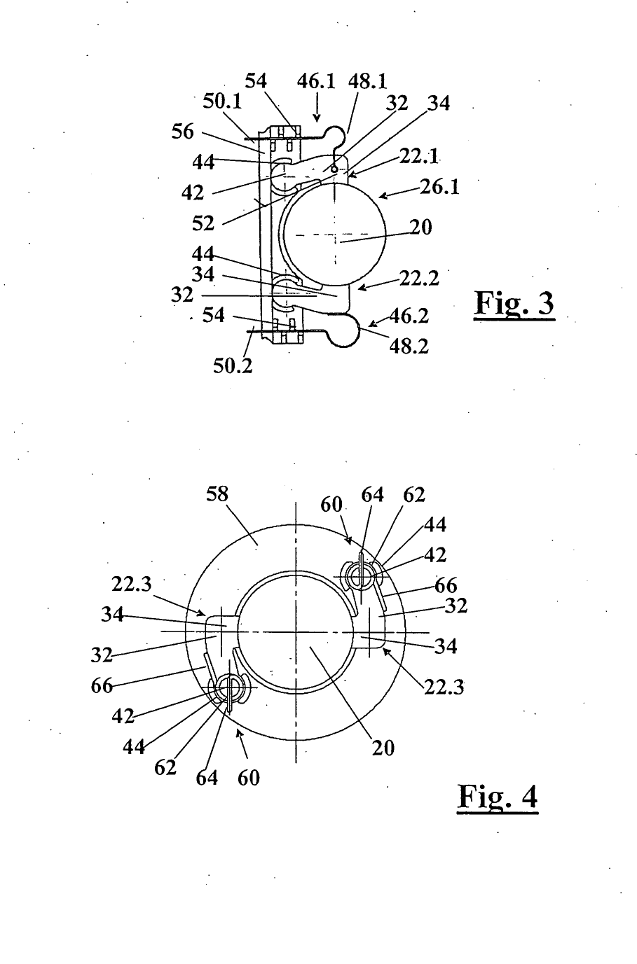

In FIG. 3, two slightly modified carbon brushes 22.1 and 22.2 are shown. The two carbon brushes 22.1, 22.2 have in common a kind of support that differs from that described above. Instead of a bore 30, the carbon brushes 22.1 and 22.2 have a cylindrical portion 42, as a bearing portion, for being received in a bearing shell 44; the bearing portions are embodied integrally with the carbon brushes 22.1, 22.2. The longitudinal axis of the cylindrical portion 42 is parallel to the commutator axis. The bearing shell 44 is embodied such that the carbon brushes 22.1 and 22.2 can be mounted via a detent or clip connection, on the one hand. On the other, the carbon brushes 22.1 and 22.2 can be pivoted sufficiently. The carbon brushes 22.1 and 22. likewise have a swivel arm 32 and a contact region 34, whose dimensions correspond to those of the carbon brush 22 in FIG. 2. Naturally once again a support as in FIG. 2 is also possible.

A spring 46.1 and 46.2 is mounted on the two carbon brushes 22.1 and 22.2, respectively, for exerting a pressure force on the swivel arm 32 or on the contact portion 34. Both springs 46.1 are preferably of resilient flat steel. Both springs 46.1 and 46.2 are secured to the swivel arm 32 and merge via a curved portion 48.1 and 48.2 with a spring arm 50.1 and 50.2 respectively, that extends substantially along the swivel arm 32 in the direction of the bearing shells 44. The spring 46.1 is connected to the carbon brush 22 via a pin 52. The spring 46.2 is welded to the swivel arm 32 of the carbon brush 22. As a result, this part can easily be prefabricated and manipulated. The spring arms 50.1 and 50.2 of the springs 46.1 and 46.2 are inserted into receiving bores 54 in the brush holder 56, in which bores they are braced on the brush holder 56. This embodiment makes it possible for both the spring suspension and the power supply to be assured simultaneously.

In FIG. 4, a further commutating device is shown, with an annular brush holder 58. The brush holder 58 can be mounted axially on a shaft 16 along with the commutator 20. Two further carbon brushes 22.3 are pivotably supported on two diametrically opposed bearing shells 44, which are disposed on one of the face ends of the brush holder 58. The carbon brushes 22.3 essentially have a shape that corresponds to the carbon brushes 22.1, 22.2. This means that they likewise have a cylindrical portion 42, a swivel arm 32, and a contact region 34. However, in addition to the cylindrical portion 42, there is a leg spring or torsion spring 60 on the bearing shell 44. The middle portion 62 of the torsion 60, which is preferably helically coiled, is disposed here in the bearing shell 44. To that end, the length of the bearing shell 44 is dimensioned such that it can receive the cylindrical portion 42 and the middle portion 62, if these are disposed one inside the other. Naturally, a peg about which the middle portion 62 of the torsion spring 60 is disposed may be provided on the cylindrical portion 42. The view in FIG. 4 in that case is the same. This applies equally to a support with pins 28 as in FIG. 2.

A first leg 64 of the torsion spring 60 is braced on the bearing shell 44 or some other component. A second leg 66 rests on the swivel arm 32 in such a way that the torsion spring 60, once the brush holder 58 has been installed, presses the contact region 34 against the commutator 20.

The torsion spring 60, which can be supported on bearings in the form of the pins 28, the bearing shells 44, or even the carbon brushes 22.3 themselves, makes a comparatively simple construction possible.

The power supply can be made via pigtails 40, as shown in FIG. 2, or via torsion springs 60, if they are welded for instance to the carbon brushes 22.3. In that case, the leg 64 can be used as a connection plug.

The bearing portions, which are embodied on the carbon brushes 22, 22.1, 22.2, 22.3 themselves or integrally with them make it possible to eliminate additional components for pivotably supporting the carbon brushes 22, 22.1, 22.2, 22.3, such as leaf springs in the case of handle brushes, or plastic holders.

Like Movassagh et al, Chinnasamy et al. prestimulated blood lymphocytes for significant periods prior to transduction with a lentiviral vector. While Chinnasamy et al. initially observed a greater than 96% transduction efficiency three days after transduction, the percentage of stably transduced cells decreased to 71.2% two weeks after transduction. Haas et al. also observed transient transduction and “pseudotransduction” in cells transduced with a lentiviral vector capable of expressing a marker gene (green fluorescent protein). Even three days post transduction, significant (over 10%) transient transduction was detected based on non-integrative expression of the marker gene in transduced primary CD34+ cord blood cells. Such expression from transient transduction remained detectable at about 5% even seven days post-transduction. Only after about 10 days post transduction did expression from transient transduction mirror that in cells transduced with a markerless vector.

Therefore, Chinnasamy et al were not able to achieve stable transduction, where an integrated form of the viral vector has been inserted into the chromosomal DNA of the transduced cell, of primary lymphocytes beyond 71.2% as reflected by the efficiency after two weeks. This was despite the use of cytokines to prestimulated the cells. Furthermore, Chinnasamy describe their inability to significantly transduce (only 3.6% 14 days post transduction) non-stimulated lymphocytes with a HIV vector that did not express accessory proteins (Vif, Vpr, Vpu and Nef), even though the cells were later stimulated with the PHA mitogen and the IL-2 cytokine post-transduction. While the results were improved somewhat with the use of non-stimulated cells and vectors containing accessory proteins, in no case was the efficiency of stable transduction of stimulated or non-stimulated cells greater than 75% on day 14 post transduction, irrespective of the stimulatory protocol used with the vector.

Low frequencies of stable transduction with lentiviral vectors was also observed by Hass et al., who could only achieve a maximum stable transduction efficiency of less than 25%, seven days post transduction, with primary CD34 positive cord blood cells. Strikingly, this 25% upper limit of transduction could not be improved even after extremely high multiplicities of infection or vector concentrations, such as a multiplicity of infection (MOI) of up to 9000 and vector concentrations of up to 10⁸ infectious units per milliliter.

Follenzi et al. also used a very high MOI of 500 to transduce cells in the presence of a three cytokine cocktail containing interleukin-3 (IL-3), interleukin-6 (IL-6) and stem cell factor (SCF). Interestingly, use of the cocktail would render the cells unsuitable for human clinical transplantation.

1-13. (canceled)

14. A carbon brush for an electrical machine for pivotable support on a brush holder of the electrical machine, the carbon brush comprising a bearing portion on the brush itself for pivotable support of the carbon brush.

15. The carbon brush as defined by claim 14, wherein the bearing portion of the carbon brush is adjoined by a swivel arm, from which a contact portion protrudes transversely for resting on a commutator of a commutator motor or on a wiper ring of a generator.

16. The carbon brush as defined by claim 15, wherein the length of the swivel arm is essentially equivalent to at least the radius of the commutator or wiper ring.

17. The carbon brush as defined by claim 14, wherein the bearing portion is embodied as a cylindrical portion for reception in a bearing shell, or wherein the bearing portion has a bore for receiving a bearing pin.

18. The carbon brush as defined by claim 14, further comprising an electrical pigtail lead secured to the swivel arm or to the contact portion.

19. The carbon brush as defined by claim 15, further comprising an electrical pigtail lead secured to the swivel arm or to the contact portion.

20. The carbon brush as defined by claim 14, further comprising a spring for exerting a pressure force on the contact portion, the spring engaging the swivel arm or the contact portion.

21. The carbon brush as defined by claim 20, wherein the spring is secured to the swivel arm and merges, via a curved portion, with a spring arm, which extends essentially along the swivel arm in the direction of the bearing portion.

22. A brush holder having bearings for pivotably supporting carbon brushes and having carbon brushes as defined by claim 14, further comprising bearing portions embodied on the carbon brushes and received in the bearings.

23. The brush holder as defined by claim 21, wherein the brush holder further comprises bearing shells or pins, on which the carbon brushes are supported.

24. The brush holder as defined by claim 22, further comprising springs secured to the carbon brushes, the springs being braced on the brush holder.

25. The brush holder as defined by claim 23, further comprising springs secured to the carbon brushes, the springs being braced on the brush holder.

26. The brush holder as defined by claim 22, further comprising torsion springs are provided, which are disposed on the bearings or on the carbon brushes, the torsion springs legs exerting the contact pressure on the carbon brushes.

27. The brush holder as defined by claim 23, further comprising torsion springs are provided, which are disposed on the bearings or on the carbon brushes, the torsion springs legs exerting the contact pressure on the carbon brushes.

28. The brush holder as defined by claim 21, further comprising spring arms embodied on the brush holder and engaging recesses of the carbon brushes.

29. The brush holder as defined by claim 22, further comprising spring arms embodied on the brush holder and engaging recesses of the carbon brushes.

30. The brush holder as defined by claim 23, further comprising spring arms embodied on the brush holder and engaging recesses of the carbon brushes.

31. The brush holder as defined by claim 24, further comprising spring arms embodied on the brush holder and engaging recesses of the carbon brushes.

32. An electrical machine comprising at least one carbon brush as defined by claim 14.

33. An electric machine comprising at least one carbon brush as defined by claim 22.
